(19) United States
(12) Patent Application Publication
(10) Pub. No.: US 2007/0252378 A1
(43) Pub. Date: Nov. 1, 2007

(54) Pharmacy label and method for preparation

(75) Inventor: Kristin B. Chambers, Chicago, IL (US)

Correspondence Address: FRANCIS KOWALIK/WALGREEN CO. LAW DEPT. M.S. 1425, 104 WILMOT ROAD, DEERFIELD, IL, 60015, US

(73) Assignee: Walgreen Co., Deerfield, IL (US)

(21) Appl. No.: 11/405,168

(22) Filed: Apr. 17, 2006

(51) Int. Cl. B42D 15/00

(52) U.S. Cl. 283/81

(57) ABSTRACT

A pharmacy label includes a main label containing printed information thereon, including patient information, drug information, instruction information, prescription information, physician information, and warning information. The label also includes one or more auxiliary labels containing additional printed information, such as patient information, drug information, instruction information, prescription information, physician information, warning information, vendor information, sale information, manufacturer information, and barcode information. The main label and auxiliary labels are removably attached to a backing sheet, and the main label and the auxiliary labels are pre-cut to be independently separable from each other and from the backing sheet.

### CROSS-REFERENCE TO RELATED APPLICATIONS

None.

### FEDERALLY SPONSORED RESEARCH OR DEVELOPMENT

None.

### TECHNICAL FIELD

The invention relates to pharmacy labels, and more specifically, to pre-cut adhesive pharmacy labels suitable for point-of-sale printing of information thereon.

### BACKGROUND OF THE INVENTION

Pharmacy labels for labeling drugs obtained from a pharmacist by prescription are well-known. Historically, most or all of the information on a pharmacy label was written by hand by the pharmacist or a pharmacy employee. Computer technology has greatly advanced the actions of collecting and keeping track of information related to a patient and prescription, and has allowed information to be printed on pharmacy labels at the point of sale, rather than handwritten. However, prior pharmacy labels and methods of creating the same have certain drawbacks and disadvantages.

The present invention is provided to solve the problems discussed above and other problems, and to provide advantages and aspects not provided by prior pharmacy labels of this type. A full discussion of the features and advantages of the present invention is deferred to the following detailed description, which proceeds with reference to the accompanying drawings.

### SUMMARY OF THE INVENTION

The present invention provides a pharmacy label including a main label containing printed information thereon, including patient information, drug information, instruction information, prescription information, physician information, and warning information. The label also includes one or more auxiliary labels containing additional printed information, such as patient information, drug information, instruction information, prescription information, physician information, warning information, vendor information, sale information, manufacturer information, and barcode information. The main label and auxiliary labels are removably attached to a backing sheet, and the main label and the auxiliary labels are pre-cut to be separable from each other after removal from the backing sheet.

According to one aspect of the invention, the main label has a first section and a second section. The first section contains the printed patient information, the printed drug information, the printed instruction information, the printed prescription information, and the printed physician information, and the second section contains the printed warning information.

According to another aspect of the invention, the information printed on the main label also includes vendor information, manufacturer information, and sale information.

According to another aspect of the invention, the information printed on the main label also includes barcode information, and the barcode information is correlated via computer to patient information and prescription information.

The present invention also provides a method of creating a pharmacy label, including several steps. A label is provided, including a backing sheet and a label portion removably attached to the backing sheet. The label portion is cut into a main label and one or more auxiliary labels, such that the main label and the auxiliary labels are separable from each other after removal from the backing sheet. Information is printed on the main label, including patient information, drug information, instruction information, prescription information, physician information, and warning information. Information is optionally printed on the auxiliary labels, containing one or more of patient information, drug information, instruction information, prescription information, physician information, warning information, manufacturer information, vendor information, sale information, and barcode information.

According to one aspect of the invention, the main label includes a first section and a second section. The patient information, drug information, instruction information, prescription information, and physician information are printed on the first section of the main label, and the warning information is printed on the second section of the main label.

According to another aspect of the invention, the method also includes the step of printing barcode information on the main label.

According to another aspect of the invention, the printing steps are performed at a point of sale and the cutting step is performed at a location remote from the point of sale.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a plan view of one embodiment of a pharmacy label of the present invention;

FIG. 2 is a perspective view of one embodiment of a pharmacy label of the present invention;

FIG. 3 is a schematic view of one embodiment of a method of creating a pharmacy label of the present invention; and

FIG. 4 is a schematic view of a computer system utilizing barcode information of the present invention.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

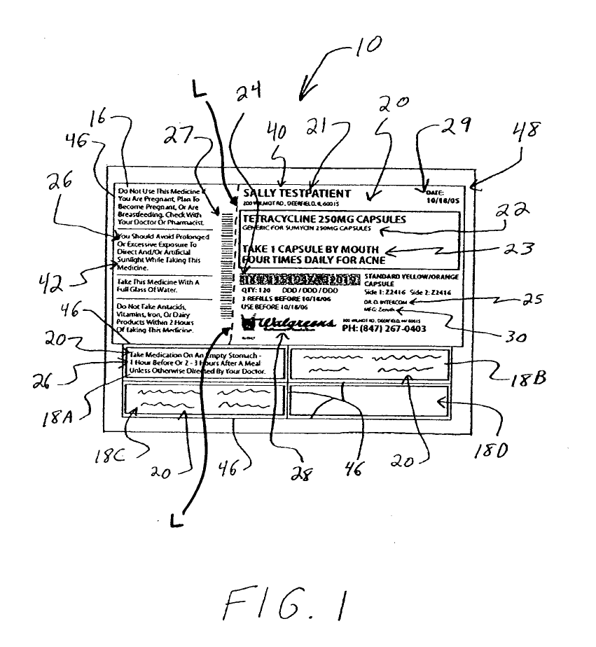

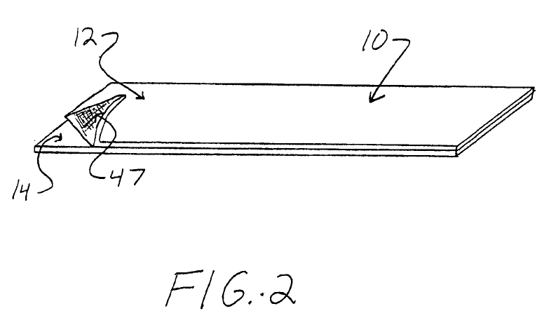

Referring to the FIGS., and initially to FIGS. 1 and 2, there is shown a pharmacy label 10 having several types of information 20 printed thereon. The label 10 preferably includes a label portion 12 and a removable backing 14 which is removably attached to the label portion. The label portion 12 includes a main label 16 and one or more auxiliary labels 18. In the embodiment shown, the label portion 12 includes four auxiliary labels 18A,18B,18C,18D. The main label 16 and auxiliary labels 18 are preferably pre-cut, and are thus separable from each other.

The label 10 includes one or more types of information 20 printed thereon. Such types of information preferably include patient information 21, drug information 22, instruction information 23, prescription information 24, physician information 25, warning information 26, barcode information 27, vendor information 28, sale information 29, and manufacturer information 30. The information 20 may also include one or more other types of useful information, including, without limitation, patient-specific, drug-specific, prescription-specific, physician-specific, and/or vendor-specific information.

Patient information 21, as shown in FIG. 1, contains information about the patient to whom the drug has been prescribed. The patient information 21 preferably includes the patient's name and address, and may also include other information, such as age, date of birth, phone number, email address, and identification information, for example a Social Security number or any other unique identification number. In different embodiments, the patient information 21 may contain any or all of the above information, and may contain additional information.

Drug information 22, as shown in FIG. 1, contains information about the drug which has been prescribed by the physician. The drug information 22 preferably includes the commercial name of the drug, the size/weight of the pills (or volume if the drug is liquid), the form of the drug (tablets, capsules, etc), and the chemical or generic name of the drug. In different embodiments, the drug information 22 may contain any or all of the above information, and may contain additional information.

Instruction information 23, as shown in FIG. 1, contains information regarding the proper method for administering the drug. The instruction information 23 preferably includes the proper dosage, the frequency of administering the drug, the means for administering the drug (mouth, injection, etc.), and the purpose for which the drug is used. In different embodiments, the instruction information 23 may contain any or all of the above information, and may contain additional information.

Prescription information 24, as shown in FIG. 1, contains information regarding the prescription rendered by the physician. The prescription information 24 preferably includes the prescription number, quantity of the drug, number of refills, expiration date of the prescription, identification information for the drug, and other information. In different embodiments, the prescription information 24 may contain any or all of the above information, and may contain additional information.

Physician information 25, as shown in FIG. 1, contains information regarding the physician who rendered the prescription. The physician information 25 preferably includes the physician's name, and may also include other information, such as the address of the physician's practice and the physician's phone number. In different embodiments, the physician information 25 may contain any or all of the above information, and may contain additional information.

Warning information 26, as shown in FIG. 1, contains information informing the patient of potential dangers or negative side effects involved with use of the drug and certain precautions to take in order to avoid or minimize potential dangers and negative side effects. The warning information 26 may include any applicable information for the drug, including warnings for patients in a certain physical condition (pregnancy, heart problems, etc.) not to use the drug, drug interaction information, warnings against certain activity while using the drug, and instructions on how and when to administer the drug to maximize its effectiveness and/or minimize potential negative side effects. Any other similar applicable information may be included within the warning information 26 as well. In different embodiments, the warning information 26 may contain any or all of the above information, and may contain additional information.

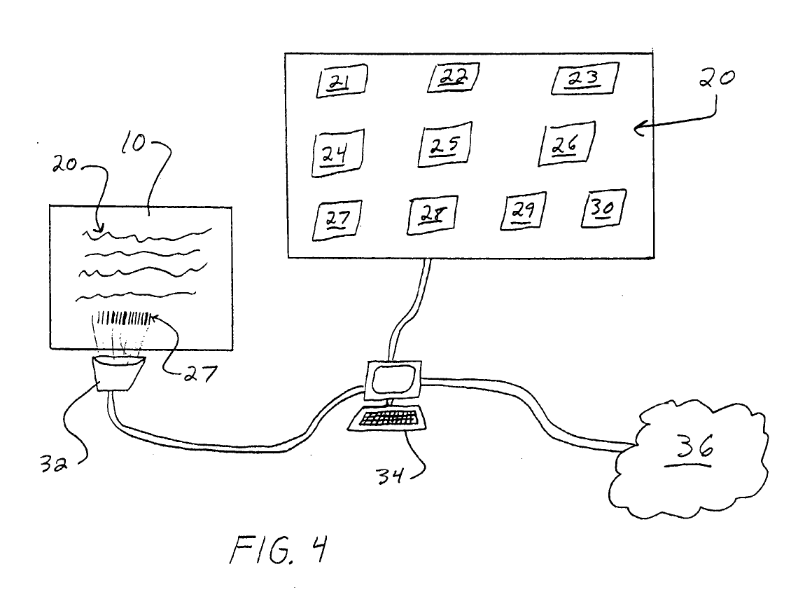

Barcode information 27, as shown in FIG. 1, comprises a machine-readable barcode, which can be used to quickly and easily correlate the label 10 with a wide variety of information. For example, as shown in FIG. 4, scanning the barcode information 27 with a scanner 32 connected to a computer 34 on a network 36 would allow the computer 34 to retrieve the prescription information 24, patient information 21, and physician information 25 from the computer 34 itself or from another computer in the network 36. Moreover, the barcode information 27 can include a link to secure information such as a patient's social security number, health insurance plan information, medical diagnoses, and even medical and prescription history. In this way, the barcode information 27 can be correlated with any or all of the information 20 identified herein and/or other types of information. Because the barcode 27 is correlated with other information, actions such as refilling prescriptions can be performed more quickly and easily by using the barcode 27.

Vendor information 28, as shown in FIG. 1, contains information regarding the vendor selling the drug to the patient. Most often, the vendor will be a pharmacy or a large store that has a pharmacy therein. The vendor information 28 preferably includes the vendor's name and/or logo, address (business and/or corporate), and phone number. In different embodiments, the vendor information 28 may contain any or all of the above information, and may contain additional information.

Sale information 29, as shown in FIG. 1, contains information regarding the sale of the drug by the vendor. The sale information 29 preferably includes the date of sale, but may also include the price and any applicable discounts or rebates. In different embodiments, the sale information 29 may contain any or all of the above information, and may contain additional information.

Manufacturer information 30, as shown in FIG. 1, contains information regarding the manufacturer who produced the drug. The manufacturer information 30 preferably includes the name of the manufacturer, but may additionally or alternately contain other information.

The information 20 is preferably printed on the label 10. “Printed,” as used herein, means automatic printing by an automatic printing device, such as a dot-matrix, inkjet, thermoprinting, or laser jet printer or other similar device. Printing is distinguished from manual methods such as handwriting or typing with a manual typewriter.

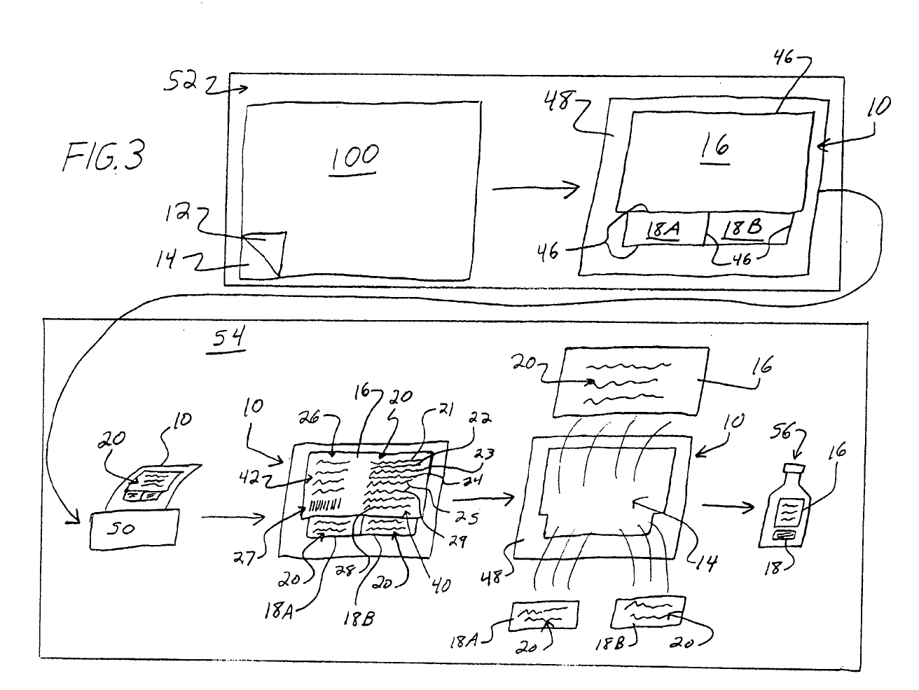

The main label 16 preferably has information 20 printed thereon, including patient information 21, drug information 22, instruction information 23, prescription information 24, physician information 25, warning information 26, barcode information 27, vendor information 28, sale information 29, and manufacturer information 30. The main label 16 preferably has a first section 40 and a second section 42, each containing information 20 printed thereon. The first section 40 and second section 42 are preferably visually distinct from each other due to factors such as the organization of the information 20 contained therein, dividing lines, and other such visual devices. The approximate boundaries of the first section 40 and second section 42 of the main label 16 are shown by the phantom dashed line (identified by the reference letter L) in FIG. 1. However, the first and second sections 40,42 are preferably not physically separate or separable without damaging the main label 16. In a preferred embodiment, the first section contains patient information 21, drug information 22, instruction information 23, prescription information 24, physician information 25, vendor information 28, sale information 29, and manufacturer information 30, and the second section includes warning information 26 and barcode information 27. In other embodiments, the main label 16 may be differently organized and may contain any or all of the above-described information or additional information. For example, the main label 16 may contain additional visually distinct sections, or may contain no visually distinct section. As shown in FIG. 1, different units or types of information 20 can be separated by dividing lines. The main label 16 is designed to be placed directly on a prescription container 56 (See FIG. 3).

As stated above, the label 10 shown in FIG. 1 contains a first auxiliary label 18A, a second auxiliary label 18B, a third auxiliary label 18C, and a fourth auxiliary label 18D. The auxiliary labels 18 are preferably located in a group on the label 10, and each auxiliary label 18A,18B,18C,18D preferably contains a small amount of information of a single type of information. The information 20 contained on the auxiliary labels 18 may be any or all of the above-identified types of information, including patient information 21, drug information 22, instruction information 23, prescription information 24, physician information 25, warning information 26, barcode information 27, vendor information 28, sale information 29, and manufacturer information 30, as well as additional information. The auxiliary labels 18 may contain information 20 that is duplicative of information 20 on the main label 16, or may contain information 20 that could not fit onto the main label 16. In one embodiment, the auxiliary labels contain additional warning information 26 and/or instruction information 23 that could not fit on the main label 16. Additionally, the auxiliary labels 18 may all contain the same type of information 20, or may contain different types of information 20. For example, in one embodiment, two of the auxiliary labels 18A,18C contain warning information 26, one of the auxiliary labels 18B contains instruction information 23, and another auxiliary label 18D contains prescription information 24. The auxiliary labels 18 may be designed to be placed on a prescription container 56 in addition to the main label 16, or may be designed to be placed elsewhere as a reminder to the patient. Further, any or all of the auxiliary labels 18A,18B,18C,18D may optionally have no information 20 printed thereon, if there is no information 20 necessary to be printed.

Prior to use, the label 10 is preferably a single piece including the backing 14, the main label 16, and the auxiliary labels 18, as illustrated in FIGS. 1 and 2. The label portion 12 preferably is pre-cut with several die cut lines 46 dividing the label portion 12 into separate parts. The main label 16 preferably has a rectangular die cut line 46 defining the edge thereof and separating the main label 16 from other parts of the label portion 12. Each auxiliary label 18A,18B,18C,18D also preferably has a rectangular die cut line 46 defining the edge thereof and separating each auxiliary label 18A,18B,18C,18D from other parts of the label portion 12. Normally, the die cut lines 46 will leave a border portion 48 of excess material from the label portion 12 surrounding the main label 16 and auxiliary labels 18. In other embodiments, the label 10, the main label 16, and/or the auxiliary labels 18 may be differently sized and shaped, and the label 10 may contain a greater or smaller number of auxiliary labels 18, thus requiring a different number and/or configuration of die cut lines 46. The label 10 should have a sufficient number of die cut lines 46 to define and separate any and all desired parts of the label portion 12. The die cut lines 46 are preferably die-cut and may be solid cuts or perforated cuts which can be easily ripped apart.

The label portion 12 is removably attached to the backing 14, preferably by an adhesive 47, as illustrated in FIG. 2. Thus, the main label 16 and auxiliary labels 18 remain attached to the backing 14 unless removed. The backing 14 is preferably a sheet of paper having a waxed surface or other low-stick surface, so the adhesive 47 can adhere to the backing 14, but releases without tearing any portion of the backing 14. Due to the die cut lines 46, the main label 16 and the auxiliary labels 18 are completely separable from each other. That is, the main label 16 may be removed from the backing 14 independently from the auxiliary labels 18. Thus, when the label 10 is desired to be used, the main label 16 is peeled from the backing 14 and affixed to a prescription container 56 or other desired article. Because the main label 16 may contain all the necessary information 20 (e.g., patient information 21, drug information 22, instruction information 23, prescription information 24, physician information 25, warning information 26, barcode information 27, vendor information 28, sale information 29 and/or manufacturer information 30), there is a significant time savings and a reduced chance that multiple labels for different prescriptions could get mixed up. If additional information 20 is required to be printed on the auxiliary labels 18, the auxiliary labels 18 must be peeled of the backing separately from the main label 16.

In a preferred embodiment, the label portion 12 is comprised of a facestock that is a smooth bright white paper with a medium sensitivity direct thermal coating, which makes it especially well suited for thermoprinting. Even more preferably, the facestock includes a topcoat to provide maximum protection from contaminants and added resistance to water and oils to prevent alteration of the above-identified types of information 20 to be printed on the label portion 12. The adhesive 47 should be well suited for adhesion to paper, corrugated paper stock and plastics. And the backing 14 should have a high internal strength and tear resistance and be well adapted to be used in roll-to-roll label applications. Material especially well suited for use in the present invention includes label material manufactured by Avery Dennison and marketed under the trade name Fasson.

The present invention also provides a method of creating the label 10. A preferred embodiment of the method is illustrated in FIG. 3, and includes several steps. It is understood that the method may not incorporate all the steps set forth below, and may contain additional steps not identified. Further, it is understood that the steps may be performed in a different order than set forth below, if feasible.

First, a blank label 100 is provided, including a backing sheet 14 and a label portion 12 removably attached to the backing sheet. The label portion 12 is then pre-cut into a main label 16 and one or more auxiliary labels 18. The label 10 shown in FIG. 3 contains a main label 16 and two auxiliary labels 18A,18B. As described above, the pre-cutting is preferably done by a die cutter. Due to the die-cutting, the main label 16 and the auxiliary labels 18A,18B may be independently removed from the backing sheet 14. Information 20 or other indicia may also be pre-printed onto the label 10. For example, in one embodiment, dividing lines and vendor information 28 are pre-printed onto the label 10. After this step, the label 10 is ready for printing. Often, the previous steps will be performed at a remote location 52, such as a manufacturing facility, and the printable labels 10 are then transported to the point of sale 54, such as a pharmacy, for printing and use. The labels 10 may be separate, or a plurality of labels 12 may be printed on a large roll of blank 100 to be later separated at the pharmacy.

When the label 10 is needed for a prescription at the point of sale 54, the pharmacy 54 can use a printer 50 or other device to print the label 10. Information 20 is printed on the main label, preferably including patient information 21, drug information 22, instruction information 23, prescription information 24, physician information 25, warning information 26, barcode information 27, vendor information 28, sale information 29, and manufacturer information 30. As stated above, the first section 40 preferably contains patient information 21, drug information 22, instruction information 23, prescription information 24, physician information 25, vendor information 28, sale information 29, and manufacturer information 30, and the second section 42 includes warning information 26 and barcode information 27. Then, the printer 50 may optionally print information 20 on the auxiliary labels 18 selected from the group consisting of: patient information 21, drug information 22, instruction information 23, prescription information 24, physician information 25, warning information 26, barcode information 27, vendor information 28, sale information 29, and manufacturer information 30. As stated above, printing on the auxiliary labels 18 may not always be necessary or desirable. The pharmacy can decide which information is necessary to be printed on the label 10, and may print different types of information on different labels 10 based on different considerations, including patient-specific, prescription-specific, or drug-specific considerations. This decision can be made by pharmacy employees or automatically by a pharmacy computer. Finally, the main label 16 and the auxiliary labels 18 may be removed from the backing 14 and applied to a suitable article or articles.

The label 10 provides many benefits. Because all of the relevant and necessary information 20 can be printed on the main label 16 and auxiliary labels 18, handwriting such information 20 is not necessary. Thus, filling prescriptions is made quicker, easier, and more convenient. Additionally, because the label 10 contains barcode information 27 correlated via computer 34 to other relevant information, such information can be retrieved simply by scanning the barcode 27. Thus, refilling prescriptions and filling other prescriptions for the same patient is made quicker, easier, and more convenient. Further, the auxiliary labels 18 provide additional space for information 20, so the label 10 can contain a great deal of information 20 that may not have fit onto prior labels. This is particularly useful in conveying additional warning information 26 to patients.

While the specific embodiments have been illustrated and described, numerous modifications come to mind without significantly departing from the spirit of the invention, and the scope of protection is only limited by the scope of the accompanying Claims.

What is claimed is:

1. A pharmacy label comprising:
a main label containing printed information comprising patient information, drug information, instruction information, prescription information, physician information, and warning information thereon;
a first auxiliary label containing printed information selected from the group consisting of: patient information, drug information, instruction information, prescription information, physician information, warning information, vendor information, sale information, manufacturer information, and barcode information; and
a removable backing sheet, wherein the main label and the first auxiliary label are removably attached to the backing sheet, and wherein the main label and the first auxiliary label are pre-cut to be independently separable from each other and from the backing sheet.

2. The pharmacy label of claim 1, wherein the main label comprises a first section and a second section, the first section containing the printed patient information, the printed drug information, the printed instruction information, the printed prescription information, and the printed physician information, and the second section containing the printed warning information.

3. The pharmacy label of claim 1, further comprising a second auxiliary label containing printed information selected from the group consisting of: patient information, drug information, instruction information, prescription information, physician information, warning information, manufacturer information, vendor information, sale information, and barcode information, wherein the second auxiliary label is removably attached to the backing sheet and is pre-cut to be separable from the main label and the first auxiliary label after removal from the backing sheet.

4. The pharmacy label of claim 3, wherein the information printed on the first auxiliary label and the information printed on the second auxiliary label are instruction information.

5. The pharmacy label of claim 3, wherein the information printed on the first auxiliary label and the information printed on the second auxiliary label are warning information.

6. The pharmacy label of claim 3, wherein the information printed on the first auxiliary label is warning information and the information printed on the second auxiliary label is instruction information.

7. The pharmacy label of claim 1, wherein the information printed on the first auxiliary label is warning information.

8. The pharmacy label of claim 1, wherein the information printed on the main label further comprises vendor information, manufacturer information, and sale information.

9. The pharmacy label of claim 1, wherein the information printed on the main label further comprises barcode information.

10. The pharmacy label of claim 9, wherein the barcode information is correlated via computer to patient information and prescription information.

11. A method of creating a pharmacy label comprising the steps of:
providing a label comprising a backing sheet and a label portion removably attached to the backing sheet;
cutting the label portion into a main label and a first auxiliary label, wherein the main label and the first auxiliary label are separable from each other after removal from the backing sheet;
printing information on the main label comprising patient information, drug information, instruction information, prescription information, physician information, and warning information; and
optionally printing information on the first auxiliary label selected from the group consisting of: patient information, drug information, instruction information, prescription information, physician information, warning information, manufacturer information, vendor information, sale information, and barcode information.

12. The method of claim 11, wherein the step of cutting the label portion further comprises cutting the label portion into the main label, the first auxiliary label, and a second auxiliary label, wherein the main label, the first auxiliary label, and the second auxiliary label are separable from each other after removal from the backing sheet, the method further comprising the step of:
optionally printing information on the second auxiliary label selected from the group consisting of: patient information, drug information, instruction information, prescription information, physician information, warning information, manufacturer information, vendor information, sale information, and barcode information.

13. The method of claim 12, wherein the information printed on the first auxiliary label and the information printed on the second auxiliary label are of the same type of information.

14. The method of claim 11, wherein the main label comprises a first section and a second section, and wherein the patient information, drug information, instruction information, prescription information, and physician information are printed on the first section of the main label, and the warning information is printed on the second section of the main label.

15. The method of claim 11, further comprising the step of:
printing barcode information on the main label.

16. The method of claim 11, wherein the steps of:
printing information on the main label comprising patient information, drug information, instruction information, prescription information, physician information, and warning information, and
optionally printing information on the first auxiliary label selected from the group consisting of: patient information, drug information, instruction information, prescription information, physician information, warning information, manufacturer information, vendor information, sale information, and barcode information are performed at a point of sale
and the steps of
providing a label comprising a backing sheet and a label portion removably attached to the backing sheet, and
cutting the label portion into a main label and a first auxiliary label, wherein the main label and the first auxiliary label are separable from each other after removal from the backing sheet are performed at a location remote from the point of sale.
